(19) United States
(12) Patent Application Publication
(10) Pub. No.: US 2004/0241395 A1
(43) Pub. Date: Dec. 2, 2004

(54) Method of modifying a surface of a substrate and articles therefrom

(75) Inventors: Naiyong Jing, Woodbury, MN (US); Caroline M. Ylitalo, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/447,772

(22) Filed: May 29, 2003

(51) Int. Cl. B32B 3/00

(52) U.S. Cl. 428/195.1

(57) ABSTRACT

A method of modifying a surface of a substrate comprises: inkjet printing a fluoropolymer solution comprising vaporizable solvent and a non-vaporizable component comprising a dissolved solid fluoropolymer. The dissolved solid fluoropolymer comprises a reaction product of at least one monomer comprising vinylidene fluoride. Various articles may be produced according to the method.

### FIELD

The present invention relates to methods for modifying a surface of a substrate.

### BACKGROUND

Wetting behavior of a liquid on a substrate surface is typically a function of the surface energy of the substrate surface and the surface tension of the liquid. At the liquid-substrate surface interface, if the molecules of the liquid have a stronger attraction to the molecules of the substrate surface than to each other (the adhesive forces are stronger than the cohesive forces), then wetting of the substrate surface generally occurs. Alternatively, if molecules of the liquid are more strongly attracted to each other than to molecules of the substrate surface (the cohesive forces are stronger than the adhesive forces), then the liquid generally beads-up and does not wet the surface of the substrate.

One way to quantify surface wetting characteristics of a liquid on a surface of a substrate is to measure the contact angle of a drop of liquid placed on that surface. The contact angle is the angle formed by the solid/liquid interface and the liquid/vapor interface measured from the side of the liquid. Liquids typically wet surfaces when their contact angle is less than 90 degrees. Typically, a decrease in the contact angle between the liquid and the surface correlates with an increase in wetting. A zero contact angle generally corresponds to spontaneous spreading of the liquid on the surface of the substrate.

For many applications, the ability to precisely control the wetting of a liquid on a surface of a substrate according to a precise high-resolution pattern is important. Thus, it would be desirable to have additional methods and materials that can provide such control.

### SUMMARY

In one aspect, the present invention provides a method for modifying a surface of a substrate comprising inkjet printing a fluoropolymer solution onto the surface of the substrate, wherein the fluoropolymer solution comprises vaporizable solvent and a non-vaporizable component comprising a dissolved solid fluoropolymer, wherein the dissolved solid fluoropolymer comprises a reaction product of at least one monomer comprising vinylidene fluoride, and wherein the dissolved solid fluoropolymer comprises at least 10 weight percent of the non-vaporizable component. In one embodiment, the monomers may further comprise at least one of hexafluoropropylene and tetrafluoroethylene. In one embodiment, the method further comprises at least partially evaporating the solvent after printing such that solid fluoropolymer is deposited as a film or coating on the substrate surface. In one embodiment, the method further comprises dissolving at least a portion of the solid fluoropolymer film in organic solvent.

In another aspect, the present invention provides an article comprising a substrate having a surface, the surface having a coating thereon comprising at least one solid fluoropolymer, wherein the solid fluoropolymer comprises a reaction product of at least one monomer comprising vinylidene fluoride, wherein the coating comprises an array of dots, and wherein the array has a resolution in at least one dimension of at least 300 dots per inch (120 dots/cm). In one embodiment, the monomers may further comprise at least one of hexafluoropropylene and tetrafluoroethylene.

Methods according to the present invention may provide high-resolution patterns, and are typically well suited for short run applications.

In this application:

all contact angles with water refer to determinations using deionized water at 22° C., unless otherwise specified;

the term “solid” means not free flowing or gaseous;

the term “vaporizable” means having a boiling point, at one atmosphere, of less than 160° C.;

the term “non-vaporizable” refers to any compound that is not “vaporizable”;

the term “polymer” refers to any compound comprising at least ten consecutive (co)polymerized monomer units, which may be the same or different; and

the term “fluoropolymer” refers to a polymer having a fluorine content of at least 20 percent by weight, based on the total weight of the polymer.

### BRIEF DESCRIPTION OF THE DRAWINGS

FIG. 1 is a pattern used to print fluoropolymer solutions used in Examples 1 and 2; and

FIG. 2 is a digital photograph of an exemplary article prepared according to the present invention that has been flood coated with water.

### DETAILED DESCRIPTION

Inkjet printable fluoropolymer solutions, used in practice of the various aspects of the present invention, comprise vaporizable solvent and a non-vaporizable component comprising at least one solid fluoropolymer.

Useful solid fluoropolymers are solid at ambient temperature (e.g., at 22° C.). For applications in which one or more solid fluoropolymers are deposited on a substrate surface and subjected to further processing (e.g., etching), solid fluoropolymers typically have a higher level of durability under such processing conditions than liquid fluoropolymers.

Useful solid fluoropolymers have a fluorine content of at least 20 percent by weight. For example, the solid fluoropolymer may have a fluorine content of at least 30 percent by weight or even at least 40 percent by weight, based on the total weight of the polymer.

Solid fluoropolymers useful in practice of the present invention are typically hydrophobic. For example, films of soluble solid fluoropolymers used in practice of the present invention may have an average receding contact angle with water of at least 80 degrees, at least 95 degrees, or at least 110 degrees, although lesser contact angles may also be useful. In some embodiments, useful solid fluoropolymers may be oleophobic as well. For example, films of soluble solid fluoropolymers used in practice of the present invention may have an average receding contact angle with hexadecane of at least 30 degrees, at least 40 degrees, or even at least 50 degrees.

Typically, since the solid fluoropolymer is in a dissolved state as applied to a substrate, it can form a continuous film (e.g., by removal of solvent). In some cases, for example to assist in film formation, it may be desirable to heat the substrate and/or solid fluoropolymer before, during, and/or after printing.

Useful solid fluoropolymers comprise a reaction product of at least one monomer comprising vinylidene fluoride (VDF). Exemplary such fluoropolymers include polyvinylidene fluoride and copolymers thereof, including those having a VDF content of at least 20, 30, 40, 50, 60, or even 70 percent up to and including 100 percent by weight of the fluoropolymer.

In one embodiment, the solid fluoropolymer may comprise a reaction product of monomers comprising VDF and hexafluoropropylene (HFP). Exemplary such fluoropolymers include copolymers of VDF and HFP having a VDF content of at least 0.01, 1, 10, 20, 30, 40, 50, 60 or even 70 percent by weight or even more, and an HFP content of at least 0.01, 1, 5, 10, 15, 20 percent by weight up to and including 30 percent by weight, based on the total weight of the fluoropolymer. An exemplary such solid fluoropolymer is a copolymer of VDF and HFP having a VDF/HFP monomer weight ratio of 90/10, available from Dyneon, LLC (Oakdale, Minn.) under the trade designation “KYNAR 2800”.

In one embodiment, the solid fluoropolymer may comprise a reaction product of monomers comprising VDF and tetrafluoroethylene (TFE). Such fluoropolymers include copolymers of VDF and TFE having a VDF content of at least 39, 50, 60, or even 70 percent by weight or more, and a TFE content of at least 0.01, 1, 5, 10, 15, 20 percent by weight up to and including 61 percent by weight, based on the total weight of the fluoropolymer. An exemplary such solid fluoropolymer is a copolymer of VDF and TFE having a VDF/TFE monomer weight ratio of 39/61, available from Dyneon, LLC under the trade designation “KYNAR 720”.

In one embodiment, the solid fluoropolymer may comprise a solvent soluble terpolymer of vinylidene fluoride (VDF), hexafluoropropylene (HFP), and tetrafluoroethylene (TFE). Such terpolymers typically have physical properties (e.g., repellency, chemical inertness, solubility, film-forming properties) that make them very useful in practice of the present invention. Such fluoropolymers include those terpolymers of VDF, HFP, and TFE having a VDF content of at least 20, 30, 40, 50, 60, or even 70 percent by weight or more, an HFP content of at least 0.01, 1, 5, 10, 15, or even 20 percent by weight up to and including 60 percent by weight, and a TFE content of at least 0.01, 1, 5, 10, 15, or even 20 percent by weight up to and including 40 percent by weight, based on the total weight of the fluoropolymer. Exemplary VDF/HFP/TFE soluble terpolymers include those commercially available from Dyneon, LLC; for example terpolymers of VDF/HFP/TFE monomers having the trade designations “THV 200” (monomer weight ratio 40/20/40), “L-5447” (monomer weight ratio 65/11/24), “KYNAR 9301 ” (monomer weight ratio 56/19/25), “DYNEON FLUOROELASTOMER FE-5530” (monomer weight ratio 63/28/9), “DYNEON FLUOROELASTOMER FT-2481” (monomer weight ratio 44/33/23), “DYNEON FLUOROELASTOMER FE-5730” (monomer weight ratio 41/35/24), and “DYNEON FLUOROELASTOMER FE-5830” (monomer weight ratio 36.6/38.5/24.9).

Optionally, various co-monomers may be copolymerized with VDF, HFP, and/or TFE. Exemplary such monomers include fluorine-containing monomers, non-fluorine-containing monomers, and combinations thereof. Examples of suitable fluorine-containing monomers include, chlorotrifluoroethylene, 3-chloropentafluoropropene, perfluorinated vinyl ethers (e.g., perfluoroalkoxy vinyl ethers and perfluoroalkyl vinyl ethers), vinyl fluoride, and fluorine-containing di-olefins such as perfluoro(diallyl ether) and perfluoro-1,3-butadiene. Exemplary suitable non-fluorine-containing monomers include olefin monomers such as ethylene, propylene, alkyl (meth)acrylate monomers (e.g., fluoroalkyl or alkyl (meth)acrylates), and the like.

Methods for preparing solid fluoropolymers are well known in the art, and include, for example, emulsion polymerization techniques as described, for example, in U.S. Pat. No. 4,338,237 (Sulzbach et al.); U.S. Pat. No. 6,489,420 (Duchesne et al.); and U.S. Pat. No. 5,285,002 (Grootaert), the disclosures of which are incorporated herein by reference.

Dissolved solid fluoropolymer(s) (i.e., a single solid fluoropolymer or a combination of more than one solid fluoropolymer) may be present at any concentration in the inkjet printable fluoropolymer solution. However, to facilitate the rate of deposition of solid fluoropolymer on the substrate surface, the concentration of solid fluoropolymer in the inkjet printable fluoropolymer solution may comprise greater than 0.001, 0.1, 1, 5, 10, or even greater than 20 percent by weight, based on the total weight of the inkjet printable fluoropolymer solution, depending on the intended application. Similarly, solid fluoropolymer may comprise at least 20, 30, 40, 50, 60, 70, 80, or even 90 percent by weight of the non-vaporizable component of the inkjet printable fluoropolymer solution. In order to obtain true polymer properties, the content of dissolved solid fluoropolymer in the inkjet printable fluoropolymer solution and/or the printing conditions (e.g., resolution and/or number of printing passes) may be adjusted to provide at least 0.5 micrometers of deposited film thickness (e.g., from 0.5 to 3 micrometers of solid fluoropolymer film thickness).

Inkjet printable fluoropolymer solutions may be prepared by combining constituent components according to one or more well known techniques such as, for example, stirring, heating, sonicating, milling, and combinations thereof.

Useful inkjet printable fluoropolymer solutions are typically film-forming upon evaporation of vaporizable solvent, since this generally results in uniform continuous coatings. Conventional solid fluoropolymer dispersions (e.g., aqueous polytetrafluoroethylene dispersions) typically have dispersing groups covalently attached to the fluoropolymer and/or added surfactant, and as conventionally used, may not yield a continuous film on evaporation. Such coatings (especially if thin) may become damaged, for example, by mild abrasion and/or by aqueous compositions (e.g., water or an aqueous etchant). On the other hand, inkjet printable fluoropolymer solutions useful in practice of the present invention may typically be formulated without the need for such dispersing groups or added surfactant, and typically have good resistance to aqueous compositions. However, compositions that do not readily form films may also be used in practice of the present invention.

Vaporizable solvent (e.g., one or more vaporizable organic solvents) should typically be present in the inkjet printable fluoropolymer solution in at least an amount sufficient to dissolve the solid fluoropolymer under the intended inkjet printing conditions. Additional vaporizable solvent beyond the amount sufficient to dissolve the solid fluoropolymer may be added to the composition, for example, to adjust the viscosity of the composition (e.g., to a viscosity suitable for a chosen inkjet printing method). For example, the composition may be adjusted by addition of solvent to a viscosity of less or equal to 30 millipascal-seconds at 60° C. Exemplary organic solvents that may be used for dissolving the solid fluoropolymer include amides (e.g., N,N-dimethylformamide), ketones (e.g., methyl ethyl ketone, acetone), alcohols (e.g., methanol, ethanol, propanol), ethers (e.g., tetrahydrofuran), hydrofluoroethers (e.g., those available from 3M Company under the trade designations “3M NOVEC ENGINEERED FLUID HFE 7100”, “3M NOVEC ENGINEERED FLUID HFE-7200”), perfluorinated solvents (e.g., that available from 3M Company under the trade designation “3M FLUORINERT ELECTRONIC LIQUID FC-77”), and combinations thereof.

Fluorinated solvents typically have very low surface tension, and may cause the inkjet printable fluoropolymer solution to become difficult to dispense by inkjet printing. Thus, it may be desirable to formulate the fluoropolymer solution such that it contains at least one non-fluorinated vaporizable solvent, for example, to adjust (e.g., increase) the surface tension of the inkjet printable fluoropolymer solution and maintain proper inkjet print head function. For example, the inkjet printable fluoropolymer solution may contain less than 20 percent, less than 10 percent, less than 5 percent, less than 1 percent by weight fluorinated solvent, or even less (e.g., less than 0.01 substantially free of fluorinated solvent).

The inkjet printable fluoropolymer solution may contain one or more optional additives such as, for example, colorants (e.g., dyes and/or pigments), thixotropes, or thickeners. However, in cases wherein that the inkjet printable fluoropolymer solution is forced through a small orifice during application to the substrate surface (e.g., inkjet printing) it may be desirable to use an inkjet printable fluoropolymer solution that is essentially free of dispersed particulates that may tend to clog the orifice.

Typically, after application of the inkjet printable fluoropolymer solution to the substrate, vaporizable solvent is at least partially (e.g., substantially completely) removed by evaporation (including drying at elevated temperature, for example, as in an oven). Evaporation may be achieved, for example, by any of a variety of conventional methods, including air drying, oven drying, microwave drying, and evaporation under reduced pressure (e.g., vacuum). During evaporation, the non-vaporizable component of the inkjet printable fluoropolymer solution is deposited on the surface of the substrate, for example, as a continuous or discontinuous thin film. The deposited non-vaporizable component typically forms a region of low surface energy on the surface of the substrate that may be used to control the wetting behavior of a fluid subsequently deposited (e.g., digitally or non-digitally) on the substrate. Exemplary such fluids include biological fluids (e.g., serum, urine, saliva, tears, and blood), adhesives and precursors thereof, water, inks, and the like.

Typically, any solid substrate may be used in practice of the present invention. For example, useful substrates may be opaque, translucent, clear, textured, patterned, rough, smooth, rigid, flexible, treated, primed, or a combination thereof. The substrate typically comprises organic and/or inorganic material. The substrate may be, for example, thermoplastic, thermoset, or a combination thereof. Exemplary substrates include films, plates, tapes, rolls, molds, sheets, blocks, molded articles, fabrics, and fiber composites (e.g., circuit boards), and may comprise at least one organic polymer such as polyimide, polyester, acrylic, polyurethane, polyether, polyolefin (e.g., polyethylene or polypropylene), polyamide, and combinations thereof. Exemplary inorganic substrates include metals (e.g., chromium, aluminum, copper, nickel, silver, gold, and alloys thereof), ceramics, glass, china, quartz, polysilicon, and combinations thereof.

The substrate may be treated, for example, to promote adhesion of the fluoropolymer film to the substrate surface. Exemplary treatments include corona, flame, and chemical treatments. Chemical treatment (e.g., treatment with a coupling agent) of the substrate surface often enhances adhesion of the inkjet printable fluoropolymer solution to the substrate surface after evaporation of solvent. Suitable coupling agents include conventional titanate coupling agents, zirconate coupling agents, and silane coupling agents that are capable of affording titanium, zirconium, or silicon oxides upon pyrolysis. Exemplary silane coupling agents include vinyltriethoxysilane, gamma-mercaptopropyl-trimethyoxysilane, allyltriethoxysilane, diallyldichlorosilane, gamma-aminopropyltrimethoxysilane, triethoxysilane, trimethoxysilane, triethoxysilanol, 3-(2-aminoethylamino)propyltrimethoxysilane, tetraethyl orthosilicate, and combinations thereof. If used, coupling agents can be applied neat or from a solution thereof in, for example, a vaporizable organic solvent. Further details on chemical surface treatment techniques are described in, for example, S. Wu “Polymer interface and Adhesion” (1982), Marcel Dekker, New York, pages 406-434.

In one embodiment, the inkjet printable fluoropolymer solution may further comprise one or more vulcanizing agents as described, for example, in U.S. Pat. No. 5,681,881 (Jing et al.), the disclosure of which is incorporated herein by reference. If present, vulcanizing agents typically comprise a portion of the non-vaporizable component.

In some cases, it may be desirable to heat the substrate after the inkjet printable fluoropolymer solution is applied. Such heating may assist in film formation of the solid fluoropolymer and/or assist in bonding the solid fluoropolymer to the substrate surface (e.g., a chemically treated surface as described above).

Typically, the inkjet printable fluoropolymer solution is applied to the substrate surface as a thin coating (e.g., less than about 1 micrometer thickness), although thicker coatings may also be used. Inkjet printable fluoropolymer solutions may be applied to the substrate surface as a continuous or discontinuous coating.

Inkjet printing methods are typically well-suited for applications wherein high resolution is desired. Exemplary inkjet printing methods include thermal inkjet printing, continuous inkjet printing, and piezoelectric (i.e., piezo) inkjet printing. Thermal inkjet printers and/or print heads are readily commercially available from printer manufacturers such as Hewlett-Packard Corporation (Palo Alto, Calif.), and Lexmark International (Lexington, Ky.). Continuous inkjet print heads are commercially available from continuous printer manufacturers such as Domino Printing Sciences (Cambridge, United Kingdom). Piezo inkjet print heads are commercially available from, for example, Trident International (Brookfield, Conn.), Epson (Torrance, Calif.), Hitachi Data Systems Corporation (Santa Clara, Calif.), Xaar PLC (Cambridge, United Kingdom), Spectra (Lebanon, N.H.), and Idanit Technologies, Limited (Rishon Le Zion, Israel). Piezo inkjet printing is one useful method for applying a solid fluoropolymer solution that typically has the flexibility to accommodate various fluids with a wide range of physical and chemical properties.

Techniques and formulation guidelines for inkjet printing are well known (see, for example, “Kirk-Othmer Encyclopedia of Chemical Technology”, Fourth Edition (1996), volume 20, John Wiley and Sons, New York, pages 112-117, the disclosure of which is incorporated herein by reference) and are within the capability of one of ordinary skill in the art. For example, inkjet printable compositions are commonly formulated to have a viscosity of less than or equal to 35 millipascal-seconds at the jetting temperature.

Inkjet printable fluoropolymer solutions used in practice of the present invention may be Newtonian or non-Newtonian (i.e., fluids that exhibit substantial shear thinning behavior). For inkjet printing, solid fluoropolymer solutions may be formulated to exhibit little or no shear thinning at the jetting temperature.

Inkjet printable fluoropolymer solutions used in practice of the present invention may be applied to any portion of the surface by various techniques including, for example, moving the substrate relative to a fixed print head, or by moving the print head relative to a fixed or movable substrate.

Inkjet printable fluoropolymer solutions used are typically inkjet printed in a predetermined pattern (although random patterns may be used) as a coating onto a surface of a substrate as an array of dots, which depending on the wetting ability and the number of printing passes may coalesce, remain separated, or a combination thereof. Exemplary patterns that may be formed by inkjet printing fluoropolymer solutions include lines (e.g., straight, curved, or bent lines) that may, for example, form a geometric outline such as a polygon or an ellipse. Depending on the resolution of the inkjet printer, the array may have a resolution in at least one dimension of at least 300 dots per inch (i.e., dpi) (120 dots/cm), 600 dpi (240 dots/cm), 900 dpi (350 dots/cm), or even greater than or equal to 1200 dpi (470 dots/cm). Exemplary patterns that may be formed by inkjet printing fluoropolymer solutions include filled or unfilled two-dimensional shapes (e.g., polygons, ellipses, circles), alphanumeric characters, and lines (e.g., straight, curved, or bent lines).

In one embodiment, the non-vaporizable component (e.g., one or more solid fluoropolymers) deposited on a surface of a substrate through evaporation of solvent may be re-dissolved in solvent, which may be the same or different from the original solvent. In such cases, the non-vaporizable component deposited on the substrate may serve as a temporary mask on the substrate surface during subsequent processes such as, for example, etching, chemical surface modification, or deposition of another material (e.g., electroplating, chemical vapor deposition).

The present invention will be more fully understood with reference to the following non-limiting examples in which all parts, percentages, ratios, and so forth, are by weight unless otherwise indicated.

### EXAMPLES

Unless otherwise noted, all reagents used in the examples were obtained, or are available, from general chemical suppliers such as Aldrich Chemical Company (Milwaukee, Wis.), or may be synthesized by known methods.

In the following examples, inkjet printing was performed as follows: the indicated solution was inkjet printed onto the indicated substrate using a piezo inkjet print head obtained under the trade designation “XJ128-200” from Xaar, PLC (Cambridge, United Kingdom). The print head was mounted in fixed position, and the substrate was mounted on an x-y translatable stage, which was moved relative to the print head while maintaining a constant distance between the print head and the stage. Printing resolution was 317×295 dots per inch (125×116 dots/cm) with a nominal drop volume of 70 picoliters.

In the following examples, contact angles were measured using deionized water and a contact angle measurement apparatus obtained under the trade designation “VCA 2500XE VIDEO CONTACT ANGLE MEASURING SYSTEM” from AST Products (Billerica, Mass.).

### Example 1

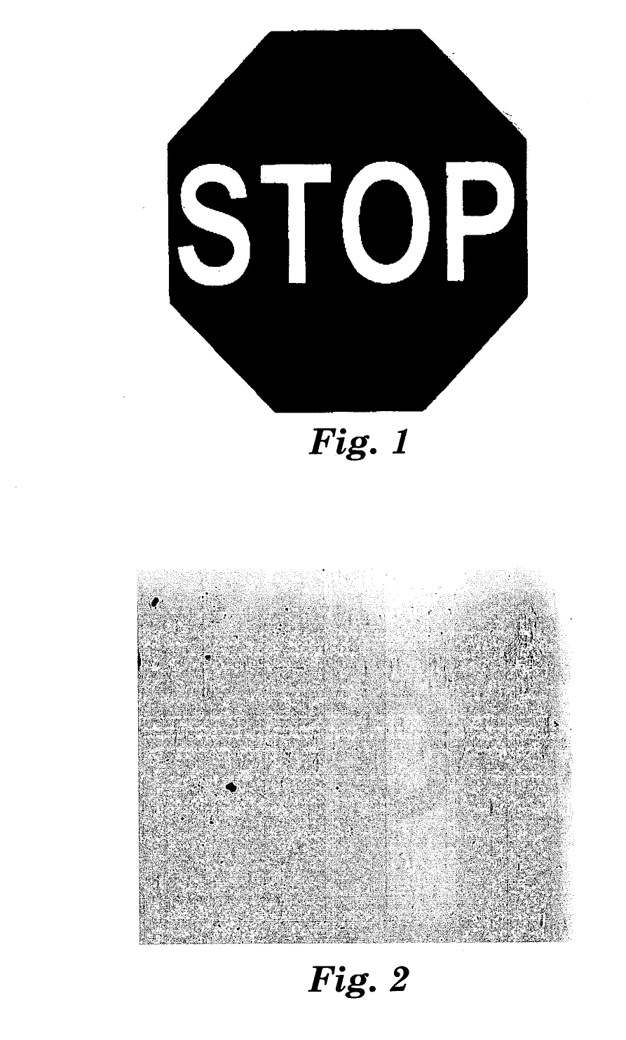

A four percent by weight solution of a terpolymer of tetrafluoroethylene, hexafluoropropylene and vinylidene fluoride obtained under the trade designation “THV 220” from Dyneon, LLC in methyl ethyl ketone was prepared using a rocker mill. The solution exhibited Newtonian behavior and had a viscosity of 4.1 millipascal-seconds. The terpolymer solution was inkjet printed, according to a pattern as shown in FIG. 1 (only dark areas of FIG. 1 were printed), onto a surface of a borosilicate glass plate that had been washed sequentially with methanol and then deionized water. During printing, the printed terpolymer solution exhibited excellent flow and wetting on the glass plate. The solvent was allowed to evaporate, thereby depositing a film of the terpolymer in printed regions of the surface of the glass plate.

After evaporation of the methyl ethyl ketone, the resultant terpolymer film formed the image of an octagon (4.5 inches (11.4 cm) height×4.5 inches (11.4 cm) width) having the letters “STOP” (0.25 inch (0.63 cm) line width) unprinted in its interior, as shown in FIG. 2, in which the letters remained unprinted. Portions of the glass plate surface that were covered with the terpolymer film exhibited a receding water contact angle of 80 degrees and a static contact angle of 102 degrees. By contrast, unprinted portions of the surface of the glass plate (the “STOP” letters) had a static contact angle with water of 38 degrees. A film of deionized water was flood coated onto the printed surface of the glass plate. The water film receded quickly from the fluoropolymer covered sections and remained on the unprinted glass sections (i.e., the “STOP” letters). The printed terpolymer film was easily removed from the glass plate by manually rubbing the film.

### Example 2

In order to improve adhesion, silane treated glass plates were used as the substrate. A borosilicate glass plate (6 inches (15 cm)×12 inches (30 cm)) was washed sequentially with methanol and then deionized water, and then dried by blowing nitrogen gas on the plate. The washed plate was then treated by immersing it for 1 minute into a 1 percent by weight solution of 3-aminopropyltriethoxysilane in methanol. The treated plate was removed from the solution and dried in air prior to printing.

The treated glass plate was printed with a four percent by weight solution of a terpolymer of tetrafluoroethylene, hexafluoropropylene and vinylidene fluoride having the trade designation “THV 200” according to the procedure of Example 1 (except that the treated glass plate was substituted for the glass plate). A film of deionized water was flood coated onto the printed glass surface. The water receded quickly from the terpolymer coated portions of the surface of the treated glass plate, and remained on the unprinted glass sections of the “STOP” pattern. However, in contrast to the sample prepared in Example 1, the printed fluoropolymer layer showed 100 percent adhesion onto the silane treated glass (measured according to ASTM D3359-02 (2002) “STANDARD TEST METHODS FOR MEASURING ADHESION BY TAPE TEST”, Method B).

A test pattern of fine lines (5 cm length, 550 micrometers line width and 550 micrometers line spacing) was also printed onto a treated glass plate using the terpolymer solution as described above. Under the magnification of a microscope (30×), a drop of deionized water was placed at one end of the printed lines on the treated glass plate (mounted horizontally). The water drop spontaneously advanced along the narrow unprinted channels of the treated glass plate defined by the printed terpolymer lines.

Various unforeseeable modifications and alterations of this invention may be made by those skilled in the art without departing from the scope and spirit of this invention, and it should be understood that this invention is not to be unduly limited to the illustrative embodiments set forth herein.

What is claimed is:

1. A method for modifying a surface of a substrate comprising inkjet printing a fluoropolymer solution onto the surface of the substrate, wherein the fluoropolymer solution comprises vaporizable solvent and a non-vaporizable component comprising a dissolved solid fluoropolymer, wherein the dissolved solid fluoropolymer comprises a reaction product of at least one monomer comprising vinylidene fluoride, and wherein the dissolved solid fluoropolymer comprises at least 10 weight percent of the non-vaporizable component.

2. A method according to claim 1, wherein the dissolved solid fluoropolymer comprises a reaction product of monomers comprising vinylidene fluoride and hexafluoropropylene.

3. A method according to claim 1, wherein the dissolved solid fluoropolymer comprises a reaction product of monomers comprising vinylidene fluoride and tetrafluoroethylene.

4. A method according to claim 1, wherein the dissolved solid fluoropolymer comprises a reaction product of monomers comprising vinylidene fluoride, hexafluoropropylene, and tetrafluoroethylene.

5. A method according to claim 1, wherein the vaporizable solvent comprises at least one non-fluorinated organic solvent.

6. A method according to claim 1, wherein the vaporizable solvent comprises less than 20 percent by weight of fluorinated organic solvent.

7. A method according to claim 1, wherein the vaporizable solvent comprises less than 10 percent by weight of fluorinated organic solvent.

8. A method according to claim 1, wherein the vaporizable solvent comprises less than 5 percent by weight of fluorinated organic solvent.

9. A method according to claim 1, wherein the vaporizable solvent is free of fluorinated organic solvent.

10. A method according to claim 1, wherein the dissolved solid fluoropolymer comprises at least 30 weight percent of the non-vaporizable component.

11. A method according to claim 1, wherein the dissolved solid fluoropolymer comprises at least 50 weight percent of the non-vaporizable component.

12. A method according to claim 1, wherein the dissolved solid fluoropolymer comprises at least 70 weight percent of the non-vaporizable component.

13. A method according to claim 1, wherein the dissolved solid fluoropolymer comprises at least 90 weight percent of the non-vaporizable component.

14. A method according to claim 1, wherein non-vaporizable component consists essentially of the dissolved solid fluoropolymer.

15. A method according to claim 1, wherein non-vaporizable component further comprises a vulcanizing agent.

16. A method according to claim 1, further comprising removing at least a portion of the vaporizable liquid component and depositing a film comprising the solid fluoropolymer on a portion of the surface of the substrate.

17. A method according to claim 16, further comprising removing at least a portion of the film.

18. A method according to claim 16, further comprising modifying at least a portion of the surface of the substrate.

19. A method according to claim 16, wherein modifying comprises at least one of etching and rinsing.

20. A method according to claim 1, wherein inkjet printing comprises piezo inkjet printing.

21. A method according to claim 1, wherein the substrate comprises at least one of polysilicon, ceramic, glass, fabric, and organic polymer.

22. A method according to claim 21, wherein organic polymer comprises polyester, polyimide, polyamide, acrylic, polyether, or a combination thereof.

23. A method according to claim 1, further comprising heating at least one of the film and the substrate.

24. A method according to claim 1, further comprising applying a coupling agent to the substrate surface.

25. A method according to claim 24, wherein the coupling agent comprises an aminoalkylsilane.

26. A method according to claim 25, further comprising heating at least one of the film and the substrate.

27. A method according to claim 1, further comprising applying a fluid to the substrate surface.

28. A method according to claim 1, wherein the fluid comprises water.

29. An article comprising a substrate having a surface, the surface having a coating thereon comprising at least one solid fluoropolymer, wherein the solid fluoropolymer comprises a reaction product of at least one monomer comprising vinylidene fluoride, wherein the coating comprises an array of dots, and wherein the array has a resolution in at least one dimension of at least 300 dots per inch.

30. An article according to claim 29, wherein the array has a resolution in at least one dimension of at least 600 dots per inch.

31. An article according to claim 29, wherein the array has a resolution in at least one dimension of at least 1200 dots per inch.

32. An article according to claim 29, wherein the solid fluoropolymer film comprises a reaction product of monomers comprising vinylidene fluoride and hexafluoropropylene.

33. An article according to claim 29, wherein the solid fluoropolymer film comprises a reaction product of monomers comprising vinylidene fluoride and tetrafluorethylene.

34. An article according to claim 29, wherein the dissolved solid fluoropolymer film comprises a reaction product of monomers comprising vinylidene fluoride, hexafluoropropylene, and tetrafluoroethylene.
